(19) United States
(12) Patent Application Publication
(10) Pub. No.: US 2009/0277701 A1
(43) Pub. Date: Nov. 12, 2009

(54) Hybrid vehicle and travel control method of hybrid vehicle

(76) Inventors: Takaya Soma, Toyota-shi (JP); Wanleng Ang, Toyota-shi (JP); Tosiaki Niwa, Okazaki-shi (JP)

Correspondence Address: OLIFF & BERRIDGE, PLC, P.O. BOX 320850, ALEXANDRIA, VA, 22320-4850, US

(21) Appl. No.: 12/311,336

(22) PCT Filed: Sep. 11, 2007
(86) PCT No.: PCT/JP2007/068029

§ 371 Date: Mar. 26, 2009

(30) Foreign Application Priority Data
Sep. 29, 2006 (JP) 2006-267710

(51) Int. Cl. B60W 20/00; B60K 6/48; G06F 19/00; B60W 10/26; B60W 10/08

(52) U.S. Cl. 180/65.25; 701/99; 903/903

(57) ABSTRACT

An SOC target is a control target of a remaining capacity of an accumulation device having a characteristic that the internal loss increases in a low SOC region. The SOC target is set to a first value corresponding to a remaining capacity target upon reaching a predetermined point when the remaining travel distance up to a predetermined point where the accumulation device can be charged from outside has become shorter than a predetermined distance. Thus, the hybrid vehicle can perform EV travel by power consumption of the accumulation device. On the other hand, when the remaining travel distance is not smaller than the predetermined distance Dr, the SOC target is set to a second value in the SOC region where the loss of the accumulation device is smaller than the first value. Thus, it is possible to reduce the power consumption in the hybrid vehicle which performs such a remaining capacity management that the remaining capacity of the accumulation device upon arrival at a predetermined point is a predetermined value.

### TECHNICAL FIELD

The invention relates to a hybrid vehicle and a travel control method of a hybrid vehicle, and particularly to a hybrid vehicle having, as its power sources, an internal combustion engine and an electric motor that can generate vehicle drive powers, respectively.

### BACKGROUND ART

In recent years, hybrid vehicles are receiving attention as environmentally friendly vehicles. The hybrid vehicle can generate a vehicle drive power by an electric motor in addition to a conventional engine. Depending on a driving state, the hybrid vehicle can appropriately select a travel manner from among driving only by the engine, driving only by the electric motor and driving by a combination of the electric motor and the engine for improving fuel consumption. Typically, when the vehicle is performing, e.g., low speed travel such as starting and thus is in a drive region of low engine efficiency, the travel control is performed to select an EV mode for driving only by the output of the electric motor. After the vehicle speed rises, the engine starts and the travel control selects the driving mode (HV mode) in which both the powers of the engine and electric motor can be used for driving.

The selection of the driving mode from between the EV and HV modes is affected by an SOC (State Of Charge) of a power storage device (typically, a secondary battery) that stores an electric drive power of the electric motor. For example, when the SOC lowers to or below a predetermined value, the engine starts for charging a battery even when the vehicle is in a low speed region. By appropriately selecting the driving mode according to the state as described above, the efficiency of use of the fuel and therefore the fuel consumption are improved, which is the distinctive feature of the hybrid vehicle.

For performing the travel control to achieve both good drivability and high efficiency of fuel consumption in the hybrid vehicle, Japanese Patent Laying-Open No. 2005-137135 Latent Document 1) has disclosed a control device of a hybrid vehicle that includes efficiency index value calculating means for calculating an efficiency index value that represent efficiency of use of fuel based on road information of a travel path of the vehicle and an SOC of a battery, final efficiency index calculating means that performs processing to change continuously the efficiency index value from a value before the updating to an updated value when the efficiency index value is updated, and thereby calculates a final efficiency index value, and drive point determining means for determining drive points of the engine and electric motor to decrease charging of the battery with increase in final efficiency index value, based on a sensed vehicle speed, a braking power command value and the final efficiency index value.

The control device of the hybrid vehicle disclosed in the Patent Document 1 controls the charge quantity of the battery according to the efficiency of use of fuel as well as road environment information provided from a navigation device, and thereby can improve the fuel consumption. Also, it suppresses rapid changes of operations points of the engine and electric motor, and thereby can improve drivability.

Japanese Patent Laying-Open No. 10-150701 (Patent Document 2) has disclosed a drive power output device that employs a battery having such characteristics that charge/discharge efficiency increases with lowering of an SOC of the battery, and appropriately sets a target SOC of the battery according to travel conditions (e.g., an average travel speed and an average change in travel) of a vehicle relating to the charge/discharge quantity of the battery. The drive power output device disclosed in the Patent Document 2 can increase the efficiency of battery charge/discharge, and can sufficiently supply the electric power required for the traveling.

Further, Japanese Patent Laying-Open No. 2003-153402 (Patent Document 3) has disclosed a secondary battery control device having the following distinctive feature. For estimating a continuation time allowing input/output of a secondary battery and thereby using the secondary battery to the limit, the control device calculates a continuation time for which the secondary battery in the present state of charge will be able to supply the electric power required for cranking, and will drive a generator to crank the engine when the calculated continuation time reaches a predetermined continuation time required for the cranking. The secondary battery control device disclosed in the Patent Document 3 can start the engine when the output of the secondary battery lowers to a limit, and thereby can use the secondary battery to a limit.

A hybrid vehicle equipped with a power storage device that can be charged by an external power supply may be used in such a manner that the power storage device is periodically charged, e.g., once a day by a predetermined charging point such as a driver's house. When the hybrid vehicle is used in this manner, an SOC of the power storage device may be managed to consume sufficiently the electric power of the power storage to a predetermined level before the vehicle reaches the above charging point, and this can suppress a fuel consumption quantity of the engine and therefore is advantageous in fuel consumption.

However, the secondary battery that is typically used as the power storage device generally has such charge/discharge efficiency characteristics that an electric power loss due to an internal resistance and the like changes according to the SOC of the secondary battery. Accordingly, when the travel control manages the SOC of the power storage device as described above, it is important to give consideration to the above characteristics for improving the fuel consumption.

In connection with the above, the Patent Document 1 has disclosed the control manner that determines the drive points of the engine and electric motor to change the quantity of charge of the battery according to whether road environment information about the vehicle drive path can be obtained or not. However, this document has not disclosed the fact that the consideration must be given to the characteristics of the charge/discharge efficiency with respect to the SOC of the battery. Further, the Patent Documents 2 and 3 has not disclosed the structure that reflects the charge/discharge efficiency characteristics of the power storage device (second battery) to the drive control related to the SOC management of the power storage device described above.

### DISCLOSURE OF THE INVENTION

The invention has been made for overcoming the above problem, and an object of the invention is to improve fuel consumption of a hybrid vehicle managing an SOC of the power storage device so that the SOC may attain a predetermined level when the vehicle arrives at a predetermined point.

A hybrid vehicle according to the invention includes an internal combustion engine and an electric motor as well as a chargeable power storage device, an electric power converting unit and a control device for controlling a whole operation of the hybrid vehicle. Each of the internal combustion engine and the electric motor is configured to generate a vehicle drive power. The power storage device has a loss characteristic changing an internal power loss during charging/discharging according to an SOC. The electric power converting unit performs electric power conversion for controlling drive of the electric motor between the power storage device and the electric motor. The control device includes an output share determining unit, an estimated travel distance obtaining unit and a target setting unit. The output share determining unit determines output shares of the internal combustion engine and the electric motor with respect to a required whole vehicle drive power, based on a vehicle drive state and a comparison between the SOC of the power storage device and an SOC target. The estimated travel distance obtaining unit obtains an estimated travel distance to a predetermined point during traveling to the predetermined point. The target setting unit sets the SOC target during traveling to the predetermined point such that the SOC attains a predetermined level when the vehicle arrives at the predetermined point. The target setting unit variably sets the SOC target according to the estimated travel distance obtained by the travel distance obtaining unit, according to the loss characteristic of the power storage device.

In a travel control method of a hybrid vehicle according to the invention, the hybrid vehicle includes an internal combustion engine and an electric motor each configured to generate a vehicle drive power as well as a chargeable power storage device and an electric power converting unit. The power storage device has a loss characteristic changing an internal power loss during charging/discharging according to an SOC. The electric power converting unit performs electric power conversion for controlling drive of the electric motor between the power storage device and the electric motor. The travel control method includes a step of determining output shares of the internal combustion engine and the electric motor with respect to a required whole vehicle drive power, based on a vehicle drive state and a comparison between the SOC of the power storage device and an SOC target, a step of obtaining an estimated travel distance to a predetermined point during traveling to the predetermined point, and a step of setting the SOC target during traveling to the predetermined point such that the SOC attains a predetermined level when the vehicle arrives at the predetermined point. The setting step variably sets the SOC target according to the estimated travel distance obtained by the obtaining step, according to the loss characteristic of the power storage device.

According to the hybrid vehicle and the travel control method of the hybrid vehicle described above, the travel in the region of a high loss is avoided according to the loss characteristic of the power storage device as far as possible so that the operation efficiency of the power storage device can be improved in the hybrid vehicle that manages the SOC of the power storage device to attain the predetermined level when the vehicle arrives at the predetermined point.

Preferably, the hybrid vehicle further includes a charge mechanism for charging the power storage device with an externally supplied electric power. The predetermined point is a preregistered point allowing external charging by the charging mechanism.

According to the above structure, the SOC of the power storage device is managed to consume sufficiently the electric power of the power storage before the vehicle reaches the charging point, and this can reduce a fuel consumption quantity of the internal combustion engine and can improve the fuel consumption of the hybrid vehicle. Further, operation efficiency of the power storage device can be improved when the vehicle travels and the SOC management is performed as described above, the fuel consumption can be further improved.

Preferably, the target setting unit sets the SOC target to be set when the estimated travel distance is equal to or longer than the predetermined distance to fall within a region causing an internal power loss in the power storage device smaller than the internal power loss caused by the predetermined level.

Further preferably, the setting step sets the SOC target to be set when the estimated travel distance is equal to or longer than the predetermined distance to fall within a region causing an internal power loss in the power storage device smaller than that caused by the predetermined level.

The above structure can avoid the operation of the power storage device in a high loss region before the remaining travel distance to the predetermined point becomes equal to or shorter than a predetermined distance. Thereby, it is possible to ensure the operation efficiency of the power storage device and further to consume sufficiently the electric power of the power storage device until the arrival at the predetermined point so that the fuel consumption of the hybrid vehicle can be improved.

Preferably, the power storage device has the loss characteristic relatively increasing the internal power loss during the charging/discharging when the SOC is low. The target setting unit sets the SOC target to be attained when the estimated travel distance is shorter than the predetermined distance to a level corresponding to the predetermined level, and sets the SOC target to be attained when the estimated travel distance is equal to or longer than the predetermined distance to fall within a region higher than the predetermined level.

Preferably, the power storage device has the loss characteristic relatively increasing the internal power loss during the charging/discharging when the SOC is low. The setting step sets the SOC target to be attained when the estimated travel distance is shorter than the predetermined distance to a level corresponding to the predetermined level, and sets the SOC target to be attained when the estimated travel distance is equal to or longer than the predetermined distance to fall within a region higher than the predetermined level.

In the power storage device having such a general loss characteristic that the internal power loss relatively increases during the charging/discharging when the SOC is low, the above structure can ensure the operation efficiency of the power storage device and further to consume sufficiently the electric power of the power storage device until the arrival at the predetermined point

Preferably, the output share determining unit includes an estimating unit estimating an allowed vehicle travel distance attainable only by the electric motor based on the SOC of the power storage device. The output share determining unit causes the electric motor to output the whole vehicle drive power when the allowed vehicle travel distance estimated by the estimating unit is longer than the estimated travel distance obtained by the estimated travel distance obtaining unit.

Further preferably, the travel control method of the hybrid vehicle further includes a step of estimating an allowed vehicle drive distance attainable only by the electric motor based on the SOC of the power storage device. The determining step causes the electric motor to output the whole vehicle drive power when the allowed vehicle travel distance estimated by the estimating step is longer than the estimated travel distance obtained by the obtaining step.

The above structure can improve the fuel consumption by actively consuming the electric power of the power storage device after it becomes possible to arrive at the predetermined point by driving the vehicle only by the output of the electric motor. Further, during the ordinary traveling before the above state, the power storage device can be used in the region of low loss so that the operation efficiency of the power storage device and therefore the fuel consumption of the hybrid vehicle can be improved.

Preferably, the output share determining unit causes the electric motor to output the whole vehicle drive power when the SOC of the power storage device is equal to or larger than an upper management limit value.

Further preferably, the determining step causes the electric motor to output the whole vehicle drive power when the SOC of the power storage device is equal to or larger than an upper management limit value.

The above structure can manage the SOC of the power storage device so that the power storage device can store a regenerative power that is generated by the electric motor during the regenerative braking of the hybrid vehicle.

Preferably, the control device further includes a deterioration determining unit for obtaining a deterioration degree of the power storage device. The target setting unit sets the SOC target to be attained when the estimated travel distance is longer than a predetermined distance, according to a loss characteristic corrected based on the deterioration degree obtained by the deterioration determining unit.

Further preferably, the travel control method of the hybrid vehicle further includes a step of obtaining a deterioration degree of the power storage device. The setting step sets the SOC target to be attained when the estimated travel distance obtained by the obtaining step is longer than a predetermined distance, according to a loss characteristic corrected based on the deterioration degree obtained by the step of obtaining the deterioration degree.

Even when the aged deterioration of the power storage device progresses, the above structure can sets the SOC target to be attained during the ordinary travel (when the estimated travel distance to the predetermined point is equal to or longer than the predetermined distance) to a region where the loss of the power storage device is low. Thereby, the operation efficiency of the power storage device and therefore the fuel consumption of the vehicle can be improved.

Preferably, the estimated travel distance obtaining unit obtains the estimated travel distance based on information provided from a navigation device capable of sensing a travel position of the hybrid vehicle. Particularly, the estimated travel distance obtaining unit obtains the estimated travel distance based on a position relationship between the predetermined point and the travel position on a map used by the navigation device, when a destination for route guidance is not set in the navigation device.

According to the above structure, the SOC management of the power storage device described above can be performed based on the information provided from a navigation system, particularly when the vehicle is not executing the guidance travel in which the predetermined point is set as the travel destination on the navigation system.

Further preferably, the control device senses that the vehicle is not traveling to the predetermined point, when a distance between a drive start point of the hybrid vehicle and the predetermined point is equal to or shorter than a predetermined distance. Alternatively, the control device senses that the vehicle is not traveling to the predetermined point, when the SOC of the power storage device at the start of the drive of the hybrid vehicle falls within a predetermined region corresponding to the time of completion of charging by the charging mechanism.

When the vehicle is traveling from the predetermined point, the above structure can prevent erroneous execution of the SOC management that achieves the SOC at the predetermined level in the power storage device when the vehicle arrives at the predetermined point.

According to the invention, it is possible to improve the fuel consumption in the hybrid vehicle performing the SOC management that achieves the SOC at the predetermined level in the power storage device when the vehicle arrives at the predetermined point.

### BRIEF DESCRIPTION OF THE DRAWINGS

FIG. 1 is a block diagram illustrating a whole schematic structure of a hybrid vehicle according to an embodiment of the invention.

FIG. 2 shows zero-phase equivalent circuits of inverters and motor generators shown in FIG. 1.

FIG. 3 is a schematic block diagram illustrating travel control of a hybrid vehicle according to a first embodiment of the invention.

FIG. 4 schematically shows a manner of obtaining a remaining travel distance by a remaining travel distance estimating unit shown in FIG. 3.

FIG. 5 schematically shows change characteristics of an open-circuit voltage of a battery (power storage device) with respect to an SOC.

FIG. 6 schematically shows change characteristics of an internal resistance of the battery (power storage device) with respect to the SOC.

FIG. 7 conceptually shows setting of an SOC target in the travel control of the hybrid vehicle according to the first embodiment.

FIG. 8 is a flowchart illustrating the travel control of the hybrid vehicle according to the first embodiment of the invention.

FIG. 9 is a schematic block diagram illustrating travel control of the hybrid vehicle according to a second embodiment of the invention.

FIG. 10 is a first flowchart illustrating the travel control of the hybrid vehicle according to the second embodiment of the invention.

FIG. 11 is a second flowchart illustrating the travel control of the hybrid vehicle according to the second embodiment of the invention.

FIG. 12 is a schematic block diagram illustrating travel control of the hybrid vehicle according to a third embodiment of the invention.

FIG. 13 conceptually shows a relationship between progress of deterioration of a battery (power storage device) and a change in internal resistance.

FIG. 14 conceptually shows setting of an SOC target in the travel control of the hybrid vehicle according to the third embodiment.

FIG. 15 is a second flowchart illustrating the travel control of the hybrid vehicle according to the third embodiment of the invention.

### BEST MODES FOR CARRYING OUT THE INVENTION

Embodiments of the invention will now be described with reference to the drawings. In the following description, the same or corresponding portions bear the same reference numbers, and description thereof is not repeated.

### First Embodiment

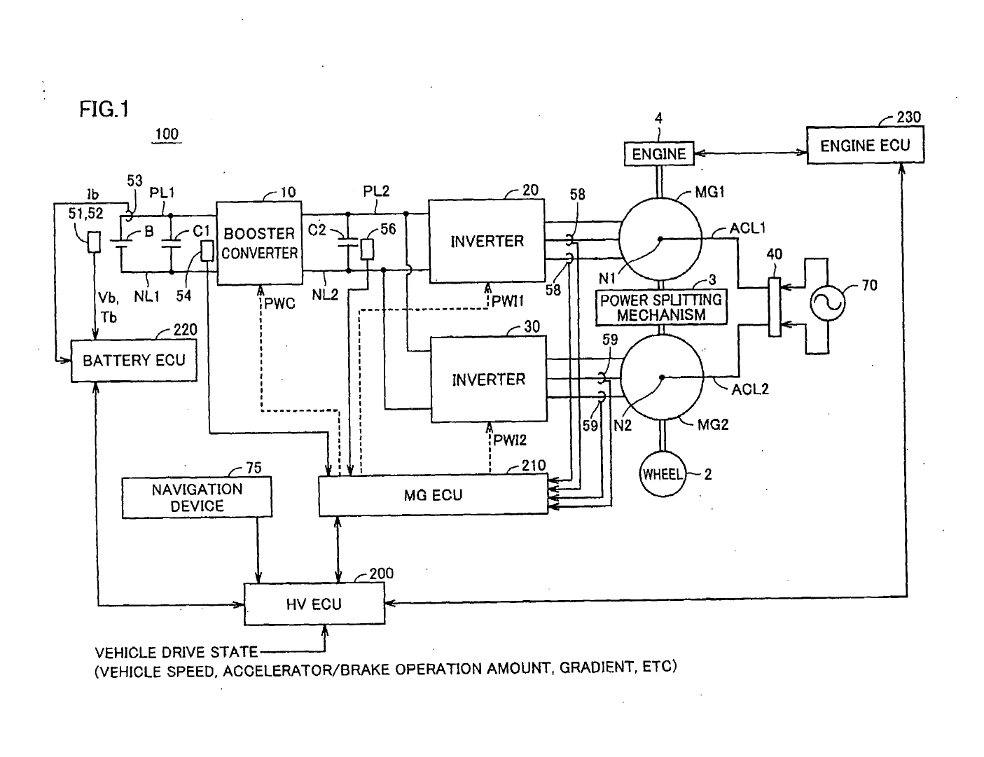

FIG. 1 is a block diagram illustrating a whole schematic structure of a hybrid vehicle according to an embodiment of the invention.

Referring to FIG. 1, a hybrid vehicle 100 includes wheels 2, a power splitting mechanism 3, an engine 4 and motor generators MG1 and MG2. Hybrid vehicle 100 further includes a power storage device B, a booster converter 10, inverters 20 and 30, a connector 40, a navigation device 75, capacitors C1 and C2, positive lines PL1 and PL2, and negative lines NL1 and NL2.

Further, hybrid vehicle 100 includes, as Electronic Control Units (ECUs) for onboard devices, an HVECU 200 controlling a whole hybrid system, an MGECU 210 controlling motor generators MG1 and MG2 as well as booster converter 10 and inverters 20 and 30, a battery ECU 220 controlling a charge/discharge state of power storage device B, and an engine ECU 230 controlling an operation state of engine 4. These ECUs are connected together for mutually transmitting data and information. Although the ECUs in the example shown in FIG. 1 are formed of independent units, respectively, two or more of these units may be formed of an integrated ECU.

Power splitting mechanism 3 is coupled to engine 4 and motor generators MG1 and MG2 for distributing the drive power among them. For example, power splitting mechanism 3 may be formed of a planetary gear having three rotation axes of a sun gear, a planetary career and a ring gear. These three rotation axes are connected to the rotation axes of engine 4 and motor generators MG1 and MG2, respectively. For example, a crankshaft of engine 4 may extend coaxially through a hollow rotor of motor generator MG1 so that engine 4 and motor generators MG1 and MG2 can mechanically be connected to power splitting mechanism 3.

Motor generator MG1 is incorporated in hybrid vehicle 100 for operation as an electric power generator driven by engine 4 as well as an electric motor that can crank engine 4. Motor generator MG2 is incorporated in hybrid vehicle 100 as an electric motor driving drive wheels 2.

Positive and negative terminals of power storage device B are connected to positive and negative lines PL1 and NL1, respectively. Capacitor C1 is connected between positive and negative lines PL1 and NL1. Booster converter 10 is connected between positive and negative lines PL1 and NL1 on one side and positive and negative lines PL2 and NL2 on the other side. Capacitor C2 is connected between positive and negative lines PL2 and NL2. Inverter 20 is connected between positive and negative lines PL2 and NL2 on one side and motor generator MG1 on the other side. Inverter 30 is connected between positive and negative lines PL2 and NL2 on one side and motor generator MG2 on the other side.

Motor generator MG1 includes Y-connected three-phase coils (not shown) as a stator coil, and is connected to inverter 20 via a three-phase cable. Motor generator MG2 likewise includes Y-connected three-phase coils (not shown) as a stator coil, and is connected to inverter 30 via a three-phase cable. A power input line ACL1 is connected to a neutral point N1 of the three-phase coils of motor generator MG1, and a power input line ACL2 is connected to a neutral point N2 of the three-phase coils of motor generator MG2.

Power storage device B is a chargeable DC power supply, and supplies a DC power to booster converter 10. Power storage device B is charged with an electric power provided from booster converter 10. Power storage device B is typically formed of a secondary battery such as a nickel-hydride battery, a lithium-ion battery or the like. Therefore, power storage device B may also be referred to simply as “battery B” hereinafter. Power storage device B may be formed of a capacitor of a large capacitance.

Battery B is provided with a temperature sensor 51, a voltage sensor 52 and a current sensor 53. A battery temperature Tb, a battery output voltage (which will be simply referred to as a “battery voltage” hereinafter) Tb and a battery input/output current (which will be simply referred to as a “battery current” hereinafter) Ib sensed by these sensors are provided to battery ECU 220. Based on these sensed values, battery ECU 220 calculates an SOC that is a state of charge of battery B (and may also be referred to as a “battery SOC” hereinafter). Battery ECU 220 transmits the battery SOC thus calculated to HVECU 200.

Capacitor C1 smoothes variations in voltage between positive and negative lines PL1 and NL1. A voltage sensor 54 senses a voltage between opposite terminals of capacitor C1, i.e., a voltage on the input side (battery side) of booster converter 10, and provides a sensed value to MGECU 210.

Booster converter 10 boosts the DC voltage provided from power storage device B based on a signal PWC from MGECU 210, and provides it to positive line PL2. Further, booster converter 10 steps down the DC voltage provided from inverters 20 and 30 to a voltage level of power storage device B for charging power storage device B. Booster converter 10 is formed of, e.g., a chopper circuit of a step-up/down type.

Capacitor C2 smoothes variation in voltage between positive and negative lines PL2 and NL2. A voltage sensor 56 senses a voltage between opposite terminals of capacitor C2, i.e., a voltage on the input side (DC side) of inverters 20 and 30, and provides a sensed value to MGECU 210.

Inverter 20 converts the DC voltage received from positive line PL2 to a three-phase AC voltage based on a signal PWI1 from MGECU 210, and provides it to motor generator MG1. Thereby, motor generator MG1 is driven to generate a designated torque. Further, inverter 20 converts the three-phase AC voltage that is generated by motor generator MG1 using the drive power of engine 4 to a DC voltage based on signal PWI1, and provides it to positive line PL2. A current sensor 58 senses a current (phase current) supplied to motor generator MG1 from inverter 20. MGECU 220 receives the sensed current value.

Based on a signal PWI2 from MGECU 210, inverter 30 converts the DC voltage received from positive line PL2 into a three-phase AC voltage and provides it to motor generator MG2. Thereby, motor generator MG2 is driven to generate a designated torque. During regenerative braking of the vehicle, inverter 30 converts the three-phase AC voltage that is generated by motor generator MG2 receiving the rotation power of wheels 2 to the DC voltage based on signal PWI2, and provides it to positive line PL2. A current sensor 59 senses the current (phase current) supplied to motor generator MG2 from inverter 30, and provides it to MGECU 220.

Motor generators MG1 and MG2 are three-phase AC electric motors and are formed of, e.g., three-phase AC synchronous electric motors, respectively. Motor generator MG1 generates the three-phase AC voltage, using the drive power of engine 4, and provides the three-phase AC voltage thus generated to inverter 20. Motor generator MG1 generates the drive power by the three-phase AC voltage received from inverter 20, and cranks engine 4. Motor generator MG2 generates the vehicle drive power by the three-phase AC voltage received from inverter 30. Also, motor generator MG2 generates the three-phase AC voltage during the regenerative braking of the vehicle, and provides it to inverter 30.

MGECU 210 produces signal PWC for driving booster converter 10 as well as signals PWI1 and PWI2 for driving respective inverters 20 and 30, and provides signals PWC, PWI1 and PWI2 thus produced to booster converter 10 and inverters 20 and 30, respectively.

HVECU 200 receives information indicating vehicle drive states such as the vehicle speed of hybrid vehicle 100, amounts of accelerator and brake operations, a gradient of road and/or the like. HVECU 200 calculates the overall drive power required in the whole vehicle based on these vehicle drive states. HVECU 200 determines the output shares of engine 4 and motor generator MG2 so that hybrid vehicle 100 can operate most efficiently, and produces the operation command so that engine 4 and motor generator MG2 may output the drive powers according to these output shares. Engine ECU 230 and MGECU 210 control engine 4 and motor generator MG2 to operate according to this operation command.

Navigation device 75 can sense the vehicle position (travel position) of hybrid vehicle 100, and provides various kinds of guidance according to the driver's request. Typically, when the driver sets a destination, it performs route guidance based on the registered road map. It is noted that when the driver has not set the destination and thus the non-guide operation is performed, navigation device 75 can estimate the remaining travel distance to the predetermined point on the road map, based on the present vehicle position and the road map. Navigation device 75 provides the information to HVECU 200.

In hybrid vehicle 100 according to this embodiment, battery (power storage device) B can be charged by an external power supply 70. As shown in FIG. 1, when connector 40 is connected to external power supply 70, inverters 20 and 30 convert the commercial powers that are supplied from external power supply 70 to neutral points N1 and N2 via power input lines ACL1 and ACL2 to the DC powers based on signals PWI1 and PWI2 provided from MGECU 210, respectively, and provide the converted DC powers to positive line PL2. More specifically, when external power supply 70 charges battery B, MGECU 210 produces signals PWI1 and PWI2 for controlling inverters 20 and 30 to convert the commercial powers that are supplied from external power supply 70 to neutral points N1 and N2 via power input lines ACL1 and ACL2 to the DC powers, respectively, and provide them to positive line PL2.

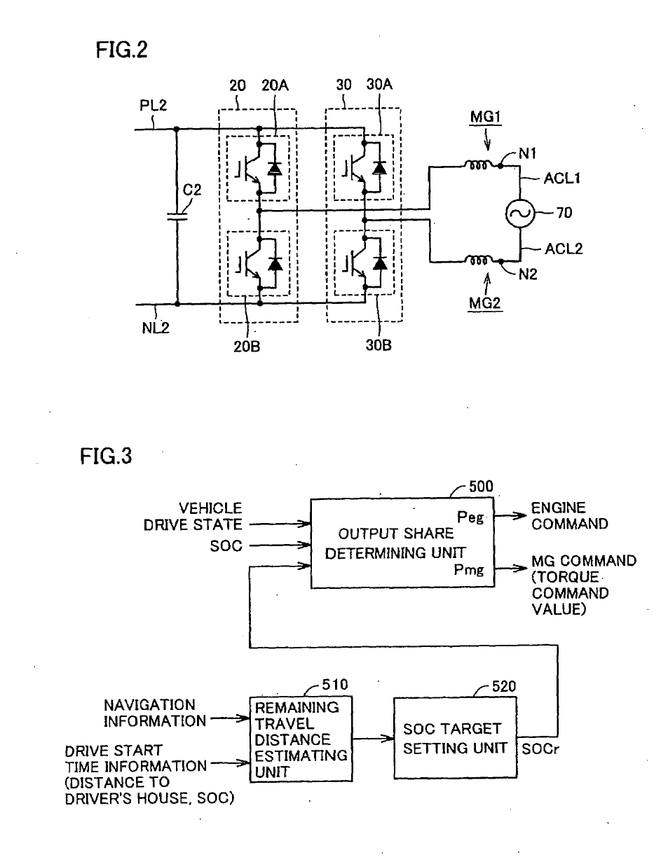

FIG. 2 shows zero-phase equivalent circuits of inverters 20 and 30 as well as motor generators MG1 and MG2 shown in FIG. 1.

Referring to FIG. 2, each of inverters 20 and 30 that are three-phase inverters, respectively, has six transistors that can be turned on/off in eight patterns. Two of the eight switching patterns exhibit an inter-phase voltage equal to zero, and this voltage state is referred to as a “zero voltage vector”. The zero voltage vector can be regarded that all the three transistors of the upper arm are in the same switching state (all on or off) and all the three transistors of the lower arm are likewise in the same switching state In FIG. 8, therefore, the tree transistors of the upper arm of inverter 20 are collectively represented as an upper arm 20A, and the three transistors of the lower arm of inverter 20 are collectively represented as a lower arm 20B. Likewise, the three transistors of the upper arm of inverter 30 are collectively represented as an upper arm 30A, and the three transistors of the lower arm of inverter 30 are collectively represented as a lower arm 30B.

As shown in FIG. 2, this zero-phase equivalent circuit can be regarded as a single-phase PWM converter that accepts input of the single-phase commercial AC powers provided to neutral points N1 and N2 via power input lines ACL1 and ACL2. Accordingly, the zero voltage vector in each of inverters 20 and 30 is changed to perform the switching control such that inverters 20 and 30 operate as the phase arms of the single-phase PWM converter, respectively. Thereby, the commercial AC power provided from power input lines ACL1 and ACL2 is converted to the DC power and is provided to positive line PL2.

It is noted that the structure of charging battery (power storage device) B by external power supply 70 is not restricted to the example in FIGS. 1 and 2. For example, a dedicated plug incorporating a charging converter or the like may be used to connect electrically external power supply 70 and battery (power storage device) B together for charging battery (power storage device) B.

HVECU 200 performs the travel control of the hybrid vehicle according to the first embodiment of the invention as described below.

FIG. 3 is a schematic block diagram illustrating the travel control of the hybrid vehicle according to the first embodiment of the invention. FIG. 3 shows the output share control performed by HVECU 200 for sharing the vehicle drive power between the engine and motor generator.

Referring to FIG. 3, HVECU 200 includes an output share determining unit 500, a remaining travel distance estimating unit 510 and an SOC target setting unit 520. In this embodiment, blocks shown in the schematic block diagram correspond to the respective functions implemented by executing predetermined programs by HVECU 200.

Output share determining unit 500 determines a vehicle drive power (required engine power) Peg provided from engine 4 and a vehicle drive power (required motor power) Pmg provided by motor generator MG2 according to the vehicle drive state and the battery SOC. In this embodiment, the whole power required in the vehicle, i.e., the sum of the above powers is not necessary the same as the power used for providing the vehicle drive power, but may include, e.g., a power generated by engine 4 for charging the battery and others used for purposes other than the vehicle driving, depending on the state or situation.

Basically, output share determining unit 500 determines required engine power Peg and required motor power Pmg so that hybrid vehicle 100 can travel at optimum efficiency. For example, in a low vehicle speed region where the efficiency of engine 4 is low, Peg is set to 0, and the vehicle performs the travel (which may also be referred to as “EV driving” hereinafter) using only the drive power provided from motor generator MG2. In a ordinary drive state where the vehicle speed is high, engine 4 operates to perform the travel using the outputs of both engine 4 and motor generator MG2. This travel may also be referred to as “HV driving” hereinafter. In this travel, the output share is controlled to keep the operation point of engine 4 in a high efficiency region and to compensate for a difference between the vehicle-required torque and the engine torque by motor generator MG2. This implements the travel with good energy efficiency and thus good fuel consumption.

In the embodiment of the invention, EVECU 200 further executes the SOC management so that the SOC of power storage device B, i.e., the battery SOC may attain a predetermined level when the vehicle arrives at the predetermined point. For example, the predetermined point corresponds to a point (typically, drive's house) where external power supply 70 for charging power storage device B is present. Also, predetermined charge service stations or the like may be registered in navigation device 75, in which case the predetermined point may be the charge service station. In hybrid vehicle 100 that allows the charging by the external power supply, the SOC management may be configured to consume fully the electric power of power storage device (battery) B except for a minimum limit power to be left before vehicle 100 arrives at the charge point (predetermined point), whereby it is possible to reduce the quantity of consumed fuel of engine 4 and to improve the fuel consumption.

For the SOC management of the power storage device described above, the travel control of the hybrid vehicle according to the embodiment of the invention is performed to set an SOC target SOCr of battery B according to the remaining travel distance to the predetermined point (driver's house) where the external charging can be performed, and thereby the control is actively performed to determine whether the EV driving can be executed or not, according to the above remaining travel distance.

In the following description of the embodiment of the invention, SOC target SOCr is simply described. However, the SOC target may simply be an SOC target value, and may also be an SOC management region. In the latter case, when SOC target SOCr changes, the upper and/or lower limits of the SOC management region change in the direction in which change target SOCr changes. In general, the hybrid vehicle has the control structure that actively selects the EV driving when the battery SOC exceeds the upper management limit. Therefore, the EV driving and the HV driving can be selected in the hybrid vehicle according to the change in SOC target value or SOC management region cause by the change in SOC target Sr.

Remaining travel distance estimating unit 510 estimates the remaining travel distance to the drive's house based on the navigation information provided from navigation device 75 and the information obtained at the start of driving. SOC target setting unit 520 sets SOC target SOCr during the vehicle traveling according to the remaining travel distance estimated by remaining travel distance estimating unit 510 so that the battery SOC may attain the target level when the vehicle arrives at the predetermined point (drivers house).

Output share determining unit 500 determines the output shares of engine 4 and motor generator MG2 with consideration given to the vehicle drive state that is a basic determination condition as well as the present battery SOC and SOC target SOCr. For example, when current battery SOC is higher than the upper management limit corresponding to SOC target SOCr, output share determining unit 500 sets required engine power Peg and required motor power Pmg to perform actively the EV driving. Thus, the EV driving mode is selected. Conversely, when it is not necessary to perform actively the EV driving in view of the management of battery SOC, the HV driving mode for traveling by the engine output and motor output or the EV driving mode is selected according to the vehicle drive state so that hybrid vehicle 100 may travel with optimum efficiency.

Output share determining unit 500 produces the engine command that is the operation command for engine 4 as well as the MG commands that are the operation commands for motor generators MG1 and MG2, so that engine 4 and motor generator MG2 may provide required engine power Peg and required motor power Pmg that are set according to the above output shares, respectively.

Not only in the case where the driver has already selected the route guidance by navigation device 75 to the predetermined point (driver's house) allowing the external charging, but also in the case where the travel destination is not set in navigation device 75 (no-guidance), remaining travel distance estimating unit 510 can successively estimate the remaining travel distance to the predetermined point based on the position relationship of the present travel position of the vehicle to the predetermined point (driver's house) already registered in the road map.

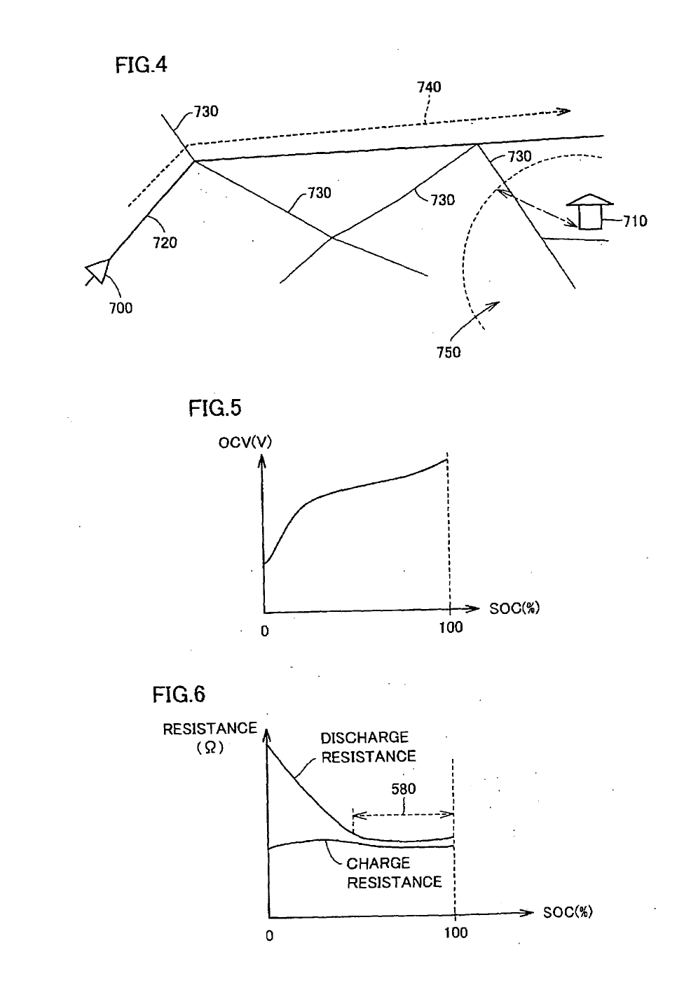

FIG. 4 shows an example of the manner in which remaining travel distance estimating unit 510 obtains the remaining travel distance.

Referring to FIG. 4, a driver's house 710 handled as the predetermined point where the power storage device can be externally charged is registered in advance on the road map registered in navigation device 75. Navigation device 75 can sense a present travel position 700 of hybrid vehicle 100.

Roads on the road map of navigation device 75 are classified into trunk roads 720 and branch roads 730. When the driver designates driver's house 710 as the travel designation in navigation device 75, it calculates the remaining travel distance to driver's house 710 according to a predetermined route guiding function. Therefore, even during the no-guidance travel already described, the remaining travel distance can be estimated by performing the calculation of the remaining travel distance as is done for the route guidance to the predetermined point (driver's house) selected as the travel designation.

Alternatively, in the no-guidance travel, navigation device 75 can perform (1) estimation of the remaining travel distance based on the linear distance to predetermined point (driver's house) 710 from present travel position, (2) estimation of the remaining travel distance by successively setting a practical travel route 740 basically following trunk roads 720 and additionally following branch roads 730 to predetermined point (driver's house) 710, (3) estimation of the remaining travel distance by successively setting the estimated travel route to predetermined point (driver's house) 710 from present travel position 710 based on learning of the past travel paths, and the like.

As described above, even when the destination is not set in navigation device 75 and thus the no-guidance travel is performed, it can estimate the remaining travel distance to the predetermined point on the road map based on the present vehicle position and the road map.

The foregoing managing of the SOC at the time of arrival at the predetermined point must not be applied to the travel starting from the predetermined point. Therefore, if the distance from hybrid vehicle 100 to the predetermined point (driver's house) is equal to or shorter than an estimated predetermined distance from the driver's house to a parking lot when hybrid vehicle 100 starts (e.g., when an ignition switch or system switch is turned on), and thus if vehicle 100 starts the travel within a region 750 shown in FIG. 4, it is not necessary to manage the SOC for the time of arrival, and it can be determined that the vehicle is leaving from the predetermined point.

Referring to FIG. 3 again, SOC target setting unit 520 sets SOC target SOCr according to the loss characteristics of battery (power storage device) B, as will be described below with reference to FIGS. 5 and 6.

FIGS. 5 and 6 conceptually illustrate general loss characteristics of battery B.

FIG. 5 shows change characteristics of an open-circuit voltage with respect to the battery SOC. When battery B is a lithium-ion battery, it remarkably exhibits the characteristics in FIG. 4. Even the general power storage device exhibits a tendency that the open-circuit voltage lowers with lowering of the SOC.

FIG. 6 shows characteristics of the internal resistance (charge resistance and discharge resistance) with respect to the battery SOC. In general, secondary batteries exhibit the characteristics shown in FIG. 5. As shown in FIG. 6, the discharge resistance rapidly increases in a low SOC region, and the discharge resistance takes a relatively stable value in a region 580 of the SOC larger than a predetermined value.

An output power Pb of battery B is expressed by the following equation (1) where Rb is an internal resistance:

Pb=Ib·Vb−Ib²·Rb (1)

According to the equation (1), when the SOC is low, an Open-Circuit Voltage (OCV) is low so that battery voltage Vb is low. Therefore, a larger battery current is required for obtaining the same power. Further, the increase in discharge resistance results in increase in internal resistance Rb so that the loss power due to the internal resistance increases.

As described above, battery B has such characteristics that the internal power loss during the charge/discharge operation changes according to the battery SOC, and typically has such loss characteristics that the increase in power loss due to the internal resistance lowers the efficiency in the low SOC region. Therefore, when it is intended to consume sufficiently the battery power before arriving at the predetermined point and battery B is operated in the low SOC region for a long time, the operation efficiency of the battery (power storage device) lowers.

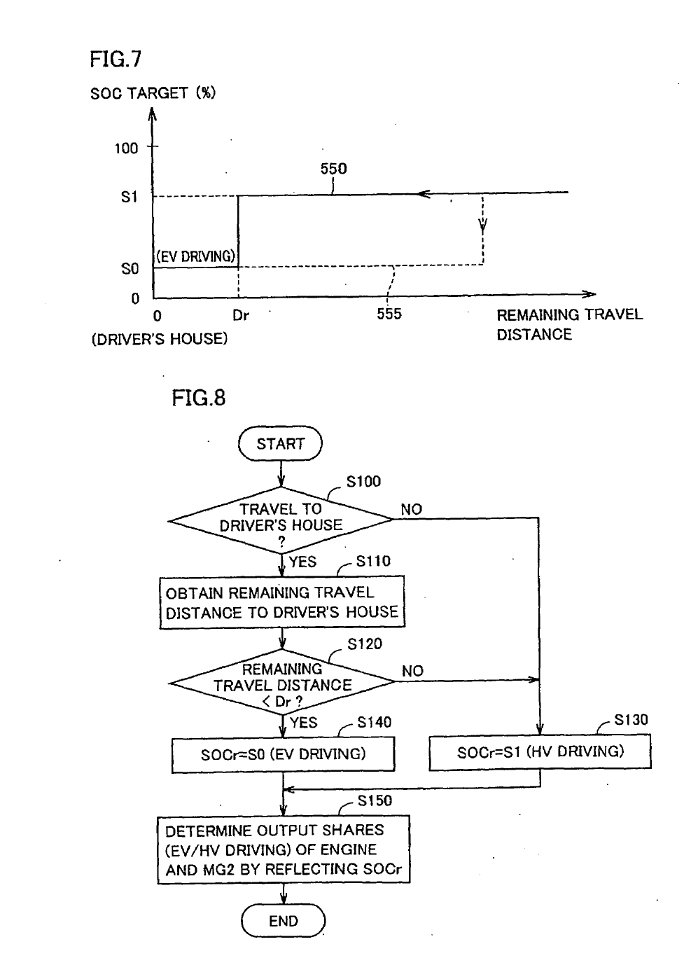

Therefore, the travel control of the hybrid vehicle according to the first embodiment sets the SOC target that is variable according to the remaining travel distance to the predetermined point (driver's house), as shown in FIG. 7.

Referring to FIG. 7, as represented by a solid line 550, SOC target setting unit 520 sets SOC target SOCr to S1 until the remaining travel distance becomes equal to a predetermined distance Dr, and sets SOCr to S0 for actively performing the EV driving when the remaining travel distance becomes shorter than predetermined distance Dr. Thus, in this embodiment, the change of SOC target from S1 to S0 is equivalent to the switching of the driving mode of hybrid vehicle 100 from the HV driving to the EV driving.

S0 is determined corresponding to the SOC target level to be attained when the vehicle arrives at the predetermined point (driver's house) allowing the external charging, and is set to the lowest level within a range that does not adversely affect the battery performance. S1 is the SOC target in the ordinary travel, takes a value falling within region 580 in FIG. 6, i.e., within the SOC region where the operation efficiency of the battery is relatively high, and is set to have a margin for storing the regenerative power produced by the regenerating braking in battery B.

Predetermined distance Dr is set based on the difference between SOC target S1 (in the ordinary travel) and S0 (at the time of arrival at the predetermined point) that are determined according to the characteristics of battery B, and particularly is set corresponding to the travel distance required for lowering the battery SOC from S1 to S0 by the EV driving.

Consequently, as represented by dotted line 555 in FIG. 7, the battery SOC at the time of arrival at the predetermined point (driver's house) attains the target level so that the operation efficiency of battery B is improved to achieve the travel of good fuel consumption, as compared with the case where SOCr is already set to S0 in a stage where the remaining travel distance is long.

FIG. 8 is a flowchart illustrating the travel control of the hybrid vehicle according to the first embodiment of the invention.

Referring to FIG. 8, HVECU 200 determines whether the travel to the predetermined chargeable point (driver's house) is being performed or not, based on the information at the start of the driving. More specifically, the distance from the driver's house at the start of the vehicle driving is equal to or shorter than the predetermined distance estimated as the distance to the parking lot, or when the battery SOC at the start of the vehicle driving is equal to or higher than the predetermined value corresponding to the fully charged state, the result of the determination in step S100 is NO. In this case, it is not necessary to perform the travel control that manages the battery SOC at the time of arrival of the predetermined point (driver's house) so that HVECU 200 sets SOC target SOCr to S1 (ordinary traveling) in step S130, and uses battery B in the region of the high operation efficiency.

In the traveling other than the start form the predetermined point (driver's house) described above or the like, it is determined that the destination of the travel is the predetermined point (driver's house) (YES in step S100), and HVECU 200 obtains the remaining travel distance to the driver's house in step S110. Thus, the processing in steps S100 and S110 implements the function of remaining travel distance estimating unit 510 shown in FIG. 3.

Further, HVECU 200 determines in step S120 whether the remaining travel distance estimated in step S110 is shorter than predetermined distance Dr (FIG. 7) or not. When the remaining travel distance is shorter than predetermined distance Dr (YES in step S120), HVECU 200 sets SOC target SOCr to S0 in step S140 and thereby selects the EV driving.

When the remaining travel distance is equal to or longer than predetermined distance Dr (NO in step S120), HVECU 200 sets SOC target SOCr to S1 in step S130, similarly to the case where the result in step S100 is NO. In this case, the HV driving is basically selected.

In step S150, HVECU 200 determines the output shares of engine 4 and motor generator MG2 by reflecting SOC target SOCr set in steps S130 and S140. According to these output shares, hybrid vehicle 100 performs the EV driving or HV driving (when Peg=0).

Thus, the processing in steps S120-S140 implements the function of SOC target setting unit 520 shown in FIG. 3, and the processing in step S150 implements the function of output share determining unit 500 shown in FIG. 3.

In the travel control of the hybrid vehicle according to the first embodiment of the invention, as described above, the SOC management can be performed to consume fully the stored power in the battery (power storage device) before the vehicle arrives at the predetermined point (driver's house) allowing the external charging, and further the travel using the low SOC region that causes a high battery loss can be avoided as far as possible. Consequently, the operation efficiency of the battery can be improved so that the overall energy efficiency of the vehicle and therefore the fuel consumption can be improved.

In the first embodiment of the invention, output share determining unit 500 corresponds to an “output share determining unit” in the invention, and remaining travel distance estimating unit 510 and SOC target setting unit 520 correspond to an “estimated travel distance obtaining unit” and a “target setting unit” in the invention, respectively. Further, step S150 in FIG. 8 corresponds to the “step of determining” in the invention, step S110 corresponds to the “step of obtaining” in the invention and steps S120-S140 correspond to the “step of setting” in the invention. The charging structure of charging battery B by external power supply 70 shown in FIG. 2 forms a “charging mechanism” in the invention, and booster converter 10 and inverters 20 and 30 shown in FIG. 1 form a “power converting unit” in the invention.

### Second Embodiment

The following embodiments will be described in connection with variations of the travel control of the hybrid vehicle described in connection with the first embodiment. In the following embodiments, therefore, the structure of hybrid vehicle 100 and the SOC management of the power storage device before the arrival at the predetermined point (driver's house) are the same as those of the first embodiment.

FIG. 9 is a schematic block diagram illustrating the travel control of the hybrid vehicle according to the second embodiment.

Referring to FIG. 9, output share determining unit 500 in the second embodiment includes an allowed EV travel distance estimating unit 502 and a full charge sensing unit 504.

Allowed EV travel distance estimating unit 502 estimates, based on the present battery SOC, a distance (allowed EV travel distance) that can be traveled only by the output of motor generator MG2. The allowed EV travel distance can be estimated by successively referring to a one-dimensional map that is already prepared using the battery SOC as an argument. Alternatively, navigation device 75 may estimate the allowed EV travel distance by further reflecting a state (presence/absence of a slope) of an estimated path to the predetermined point (driver's house).

Full charge sensing unit 504 determines whether battery B is fully charged or not, based on the present battery SOC.

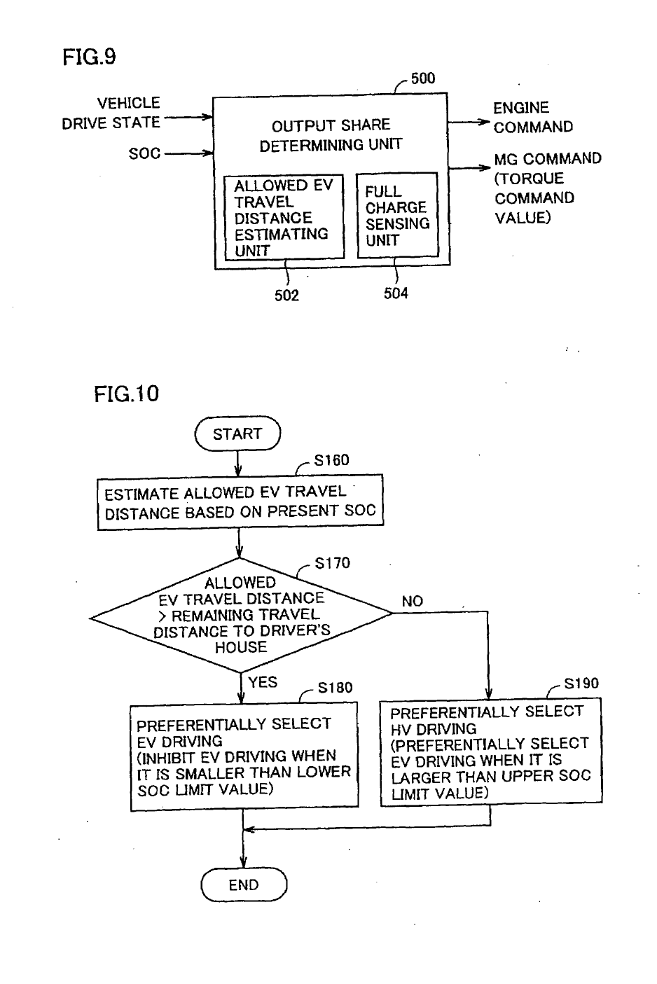

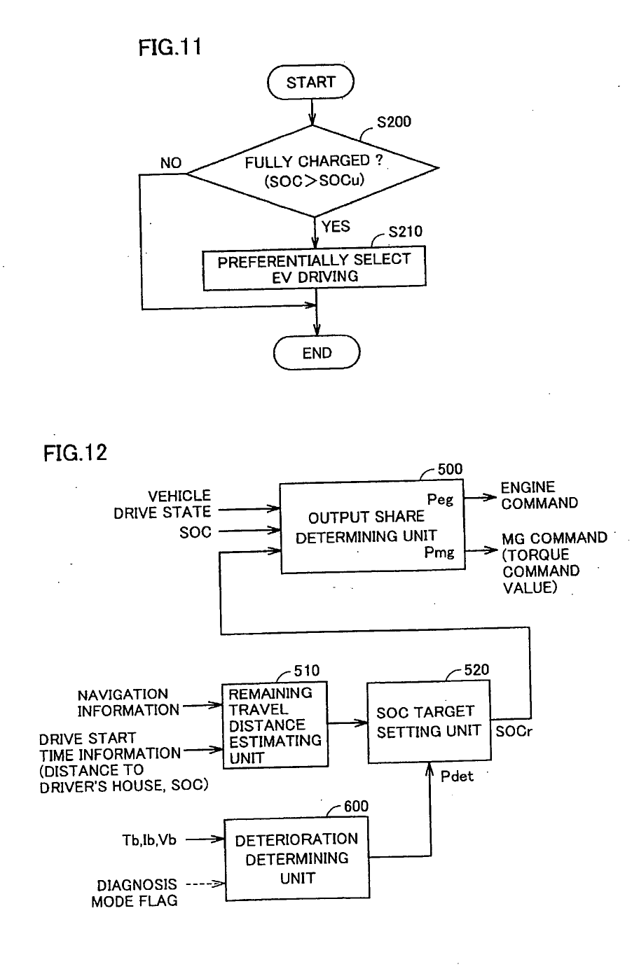

FIG. 10 is a first flowchart illustrating the travel control of the hybrid vehicle according to the second embodiment.

Referring to FIG. 10, HVECU 200 estimates the allowed EV travel distance based on the present battery SOC in step S160. In step S170, HVECU 200 compares the allowed EV travel distance estimated in step S160 with the remaining travel distance to the predetermined point (driver's house). This remaining travel distance can be obtained similarly to the first embodiment.

When the allowed EV travel distance is longer than the remaining travel distance (YES in step S170), HVECU 200 preferentially selects the EV driving. For example, the EV driving can be preferentially selected by setting SOC target SOCr at S0 similarly to the processing in step S140 of FIG. 6.

However, when the present battery SOC is lower than a lower SOC management limit, or when the output of motor generator MG2 is insufficient for the whole required power of the vehicle, engine 4 starts to drive using the output of engine 4.

When the allowed EV travel distance is shorter than the remaining travel distance to the driver's house (NO in step S170), HVECU 200 preferentially selects the HV driving to perform the travel using engine 4 in step S190. For example, SOC target SOCr is set to S1 in step S190, similarly to step S130 in FIG. 8. However, when the present SOC exceeds the upper SOC management limit, the EV driving is preferentially executed for actively using the electric power of battery B.

More specifically, the flowchart shown in FIG. 10 implements the travel control of the hybrid vehicle that uses the allowed EV travel distance estimated by allowed EV travel distance estimating unit 502 as predetermined distance Dr in step S120 of the first embodiment in FIGS. 7 and 8. Thereby, predetermined distance Dr in the first embodiment can be appropriately reduced so that the operation efficiency of the battery and therefore the fuel consumption can be improved by minimizing the travel in the low SOC region where the loss of battery B is high.

When battery B is fully charged, the battery cannot store the electric power generated by the regenerative braking of hybrid vehicle 100 so that the whole energy efficiency of the vehicle lowers. Therefore, HVECU 200 performs the travel control shown in FIG. 11 when battery B is fully charged.

Referring to FIG. 11, HVECU 200 determines in step S200 whether the present battery SOC is larger than an upper management value limit SOCu corresponding to the fully charged state or not. Upper management value limit SOCu is set, e.g., to 80 (%).

When battery B is fully charged (YES in step S200), HVECU 200 preferentially selects the EV driving independently of the remaining travel distance to the predetermined point (driver's house) in step S210. When battery B is not fully charged (NO in step S200), the travel control already described is performed.

Thereby, when the battery (power storage device) is fully charged, the battery power is actively consumed to perform the EV driving, and thereby battery B can have a margin for accepting the regenerative power during the regenerative braking. Consequently, it is possible to improve the energy efficiency of the whole hybrid vehicle and thereby to improve the fuel consumption.

In the second embodiment of the invention, allowed EV travel distance estimating unit 502 corresponds to the “estimating unit” in the invention, and step S160 in FIG. 10 corresponds to the “step of estimating” in the invention.

### Third Embodiment

The third embodiment will be described in connection with the travel control reflecting a progression of deterioration of battery B (power storage device).

FIG. 12 is a schematic block diagram illustrating the travel control of the hybrid vehicle according to the third embodiment of the invention.

As can be understood from a comparison between FIGS. 12 and 3, the travel control of the hybrid vehicle according to the third embodiment is further provided with a deterioration determining unit 600. Deterioration determining unit 600 obtains a deterioration degree of battery B (power storage device) based on temperature Tb, current Ib, voltage Vb and the like of battery B.

For example, the vehicle may enter a diagnosis mode in which battery B outputs a constant pulse-like current after the drive of hybrid vehicle ended, and the deterioration degree of battery B is estimated based on a battery behavior (e.g., a battery voltage behavior or the like after the output of the pulse-like current) in this diagnosis mode. For example, this diagnosis mode may be periodically executed in response to traveling of a certain distance or elapsing of a certain time, and thereby deterioration determining unit 600 can obtain a parameter Pdet indicating the deterioration degree of battery B.

Alternatively, the particular diagnosis mode may not be employed, and the deterioration degree of battery B may be obtained by obtaining internal resistance Rb of battery B from battery voltage Vb and battery current Ib. More specifically, deterioration determining unit 600 may determine parameter Pdet indicating the deterioration degree of battery B based on a comparison of present internal resistance Rb with a relationship that has been obtained between the deterioration degree and the internal resistance value for each battery use condition (each of battery temperature Tb, battery current Ib and the like).

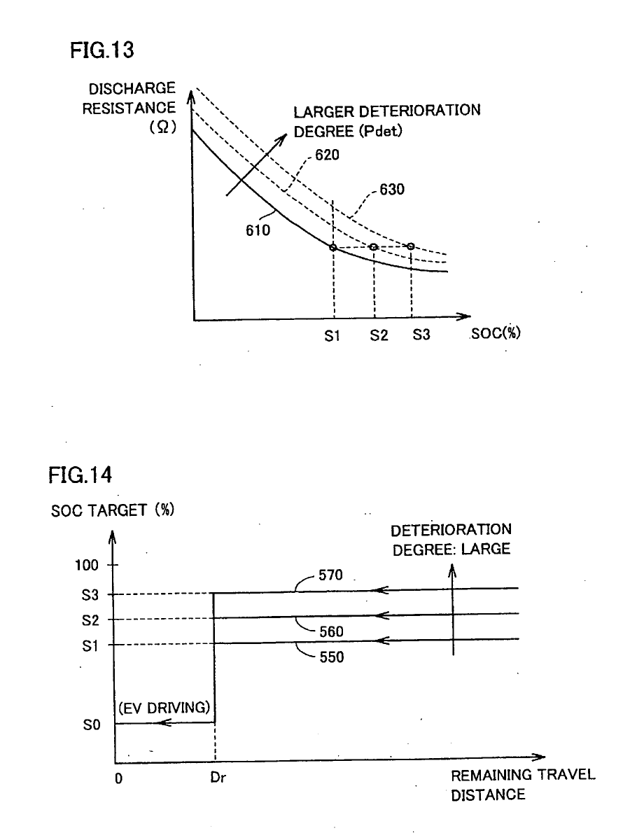

FIG. 13 conceptually shows a relationship between the progression of deterioration of battery B and the change in internal resistance.

Referring to FIG. 13, the discharge resistance of battery B (power storage device) gradually increases with progression of the deterioration. For example, as the deterioration of battery B progresses, the discharge resistance gradually increases as shown by characteristics 620 or 630 when the SOC is constant, as compared with characteristics 610 of the new battery.

Therefore, even when the SOC target S1 for the ordinary operation was been set based on characteristics 610 exhibited in the new state, the internal resistance loss in battery B increases as the deterioration of battery B progresses so that the battery operation efficiency and the energy efficiency of the whole vehicle lower, and the fuel consumption of the vehicle deteriorates.

According to the travel control of the hybrid vehicle in the third embodiment, therefore, the SOC target in the normal state, i.e., the SOC target that is set before lowering it for preferentially performing the EV driving in the first and second embodiments is changed according to the degree of deterioration of battery B (power storage device). For example, in the state indicated by characteristics 620 in FIG. 13, the SOC target is set at S2, whereby the battery operation efficiency equivalent to that attained when the SOC target is set at S1 in the state of characteristics 610. Likewise, when power storage device B is further deteriorated to exhibit characteristics 630, it is necessary to increase the SOC target at S3 for obtaining the battery operation efficiency equivalent to the above.

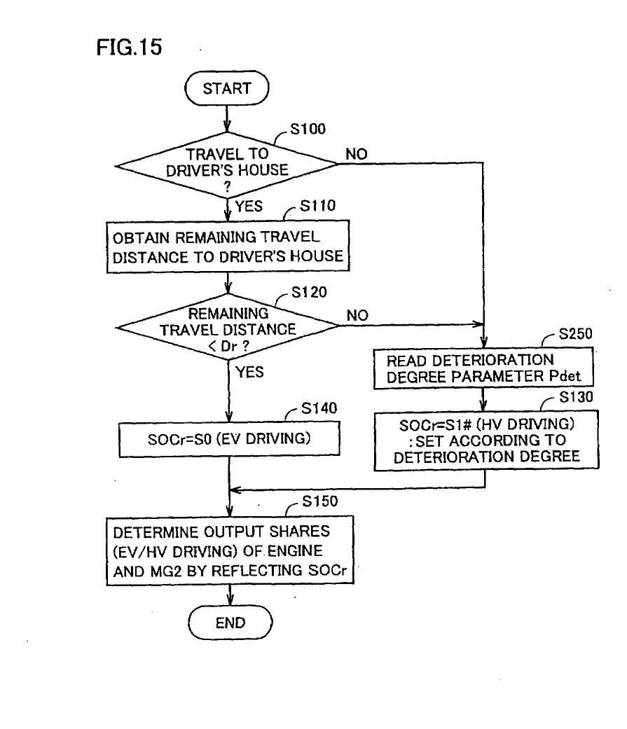

FIG. 14 is a diagram to be compared with FIG. 7, and conceptually shows setting of the SOC target in the travel control of the hybrid vehicle according to the third embodiment.

Referring to FIG. 14, when the deterioration battery B has not remarkably progressed as compared with the new state, the setting is performed as indicated by “550”, similarly to FIG. 7. More specifically, SOC target SOCr is set at S1 in the ordinary state before the remaining travel distance attains predetermined distance Dr. When the remaining travel distance becomes shorter that predetermined distance Dr, SOC target SOCr is set at S0 so that the EV driving is actively performed.

Further, the SOC target in the ordinary state is set to fall within the SOC region higher than that before the progression of deterioration, as indicated by “560” and “570”, based on characteristics 620 and 630 that are corrected according to parameter Pdet indicating the degree of deterioration of battery B (power storage device).

FIG. 15 is a second flowchart illustrating a travel control of a hybrid vehicle according to a third embodiment of the invention.

As can be understood from the comparison between FIGS. 15 and 8, HVECU 200 further executes a step S250 in the travel control of the hybrid vehicle according to the third embodiment. In step S250, HVECU 200 reads deterioration degree parameter Pdet from deterioration determining unit 600. In step S130, HVECU 200 sets SOC target S1# for the ordinary state according to deterioration degree parameter Pdet thus read, based on the characteristics corrected according to the deterioration degree. Other processing in the flowchart of FIG. 15 is substantially the same as that in FIG. 8, and therefore description thereof is not repeated.

Owing to the above structure, the travel control of the hybrid vehicle according to the third embodiment can prevent the lowering of the battery operation efficiency in the ordinary travel operation and thereby can improve the fuel consumption of the vehicle, even when the aged deterioration of battery B (power storage device) progresses in the travel control of the hybrid vehicle of the first or second embodiment.

In the third embodiment of the invention, deterioration determining unit 600 corresponds to a “deterioration determining unit” in the invention, and step S250 in FIG. 15 corresponds to the “step of obtaining a deterioration degree” in the invention.

The structure of the hybrid vehicle shown in FIG. 1 has been described by way of example, and it is noted that the invention can be applied to various structures of the hybrid vehicle provided that the vehicle is equipped with an electric motor generating a drive power from an electric power of a power storage device, and a drive power source other than the electric motor, and performs SOC management to attain a predetermined level of an SOC of the power storage device at the time of arrival at the predetermined point.

Although the present invention has been described and illustrated in detail, it is clearly understood that the same is by way of illustration and example only and is not to be taken by way of limitation, the scope of the present invention being interpreted by the terms of the appended claims.

### INDUSTRIAL APPLICABILITY

The invention can be applied to a hybrid vehicle including an electric motor that can generate a vehicle drive power from a stored electric power, and another drive power source generating the vehicle drive power from energy other than the electric power.

1. A hybrid vehicle comprising:
an internal combustion engine and an electric motor each configured to generate a vehicle drive power;
a chargeable power storage device having a loss characteristic changing an internal power loss during charging/discharging according to an SOC and relatively increasing the internal power loss during the charging/discharging when the SOC is low;
an electric power converting unit performing electric power conversion for controlling drive of said electric motor between said power storage device and said electric motor; and
a control device for controlling a whole operation of said hybrid vehicle,
said control device including:
an output share determining unit determining output shares of said internal combustion engine and said electric motor with respect to a required whole vehicle drive power, based on a vehicle drive state and a comparison between the SOC of said power storage device and an SOC target,
an estimated travel distance obtaining unit obtaining an estimated travel distance to a predetermined point during traveling to said predetermined point, and
a target setting unit setting said SOC target during traveling to said predetermined point such that said SOC attains a predetermined level when the vehicle arrives at said predetermined point, and
said target setting unit variably sets said SOC target according to said estimated travel distance obtained by said travel distance obtaining unit according to the loss characteristic of said power storage device, sets said SOC target to be attained when said estimated travel distance is shorter than said predetermined distance to a level corresponding to said predetermined level, and sets said SOC target to be attained when said estimated travel distance is equal to or longer than said predetermined distance to fall within a region higher than said predetermined level.

2. The hybrid vehicle according to claim 1, further comprising a charge mechanism for charging said power storage device with an externally supplied electric power, wherein
said predetermined point is a preregistered point allowing external charging by said charging mechanism.

3. The hybrid vehicle according to claim 1, wherein
said target setting unit sets said SOC target to be set when said estimated travel distance is equal to or longer than a predetermined distance to fall within a region causing an internal power loss in said power storage device smaller than the internal power loss caused by said predetermined level.

4. (canceled)

5. The hybrid vehicle according to claim 1, wherein
said output share determining unit includes an estimating unit estimating an allowed vehicle travel distance attainable only by said electric motor, based on the SOC of said power storage device, and
said output share determining unit causes said electric motor to output said whole vehicle drive power when the allowed vehicle travel distance estimated by said estimating unit is longer than said estimated travel distance obtained by said estimated travel distance obtaining unit.

6. The hybrid vehicle according to claim 1, wherein
said output share determining unit causes said electric motor to output said whole vehicle drive power when the SOC of said power storage device is equal to or larger than an upper management limit value.

7. The hybrid vehicle according to claim 1, wherein
said control device further includes a deterioration determining unit for obtaining a deterioration degree of said power storage device, and
said target setting unit sets said SOC target to be attained when said estimated travel distance is longer than a predetermined distance, according to a loss characteristic corrected based on the deterioration degree obtained by said deterioration determining unit.

8. The hybrid vehicle according to claim 1, wherein
said estimated travel distance obtaining unit obtains said estimated travel distance based on information provided from a navigation device capable of sensing a travel position of said hybrid vehicle.

9. The hybrid vehicle according to claim 8, wherein
said estimated travel distance obtaining unit obtains said estimated travel distance based on a position relationship between said predetermined point and said travel position on a map used by said navigation device, when a destination for route guidance is not set in said navigation device.

10. The hybrid vehicle according to claim 1, wherein
said control device disables the variable setting of said SOC target by said target setting unit, when a distance between a drive start point of said hybrid vehicle and said predetermined point is equal to or shorter than a predetermined distance.

11. The hybrid vehicle according to claim 2, wherein
said control device disables the variable setting of said SOC target by said target setting unit, when the SOC of said power storage device at the start of the drive of said hybrid vehicle falls within a predetermined region corresponding to the time of completion of charging by said charging mechanism.

12. A travel control method of a hybrid vehicle, wherein
said hybrid vehicle including:
an internal combustion engine and an electric motor each configured to generate a vehicle drive power,
a chargeable power storage device having a loss characteristic changing an internal power loss during charging/discharging according to an SOC and relatively increasing the internal power loss during the charging/discharging when the SOC is low, and
an electric power converting unit performing electric power conversion for controlling drive of said electric motor between said power storage device and said electric motor; and
said travel control method comprising the steps of:
determining output shares of said internal combustion engine and said electric motor with respect to a required whole vehicle drive power, based on a vehicle drive state and a comparison between the SOC of said power storage device and an SOC target;
obtaining an estimated travel distance to a predetermined point during traveling to said predetermined point; and
setting said SOC target during traveling to said predetermined point such that said SOC attains a predetermined level when the vehicle arrives at said predetermined point; and
said step of setting variably sets said SOC target according to said estimated travel distance obtained by said step of obtaining according to the loss characteristic of said power storage device, sets said SOC target to be attained when said estimated travel distance is shorter than said predetermined distance to a level corresponding to said predetermined level, and sets said SOC target to be attained when said estimated travel distance is equal to or longer than said predetermined distance to fall within a region higher than said predetermined level.

13. The travel control method of the hybrid vehicle according to claim 12, wherein
said hybrid vehicle further includes a charge mechanism for charging said power storage device with an externally supplied electric power, and
said predetermined point is a preregistered point allowing external charging by said charging mechanism.

14. The travel control method of the hybrid vehicle according to claim 12, wherein
said step of setting sets said SOC target to be set when said estimated travel distance obtained by said step of obtaining is equal to or longer than a predetermined distance to fall within a region causing an internal power loss in said power storage device smaller than the internal power loss caused by said predetermined level.

15. (canceled)

16. The travel control method of the hybrid vehicle according to claim 12, further comprising;
the step of estimating an allowed vehicle travel distance attainable only by said electric motor based on the SOC of said power storage device, and
said step of determining causes said electric motor to output said whole vehicle drive power when the allowed vehicle travel distance estimated by said step of estimating is longer than said estimated travel distance obtained by said step of obtaining.

17. The travel control method of the hybrid vehicle according to claim 12, wherein
said step of determining causes said electric motor to output said whole vehicle drive power when the SOC of said power storage device is larger than an upper management limit value.

18. The travel control method of the hybrid vehicle according to claim 12, further comprising:
the step of obtaining a deterioration degree of said power storage device, wherein
said step of setting sets said SOC target to be attained when said estimated travel distance is equal to or longer than a predetermined distance, according to a loss characteristic corrected based on the deterioration degree obtained by said step of obtaining the deterioration degree.
